(19) United States
(12) Patent Application Publication
(10) Pub. No.: US 2007/0188713 A1
(43) Pub. Date: Aug. 16, 2007

(54) Simplified polarization recovery system

(76) Inventors: Estill Thone Hall JR., Indianapolis, IN (US); Valter Drazic, Betton (FR); Jason Alan Ridenour, South Bend, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/590,428

(22) PCT Filed: Feb. 25, 2004
(86) PCT No.: PCT/US04/05480

§ 371 Date: Aug. 23, 2006

(51) Int. Cl. G02B 26/00; G03B 21/14

(52) U.S. Cl. 353/20; 359/237

(57) ABSTRACT

A polarized light source, is provided, comprising a lamp providing randomly polarized light, an integrator for directing light from the lamp generally along an axis of the integrator, and a wire-grid polarizer disposed at one end of the integrator. This polarized light source recovers a portion of the light produced by the lamp having an undesired polarization. A Liquid Crystal on Silicon (LCOS) light engine including a polarized light source with polarization recovery is also provided.

### FIELD OF THE INVENTION

This invention is related to an apparatus and method for producing more polarized light of the desired polarization in a Liquid Crystal on Silicon (LCOS) light engine.

### BACKGROUND OF THE INVENTION

Liquid Crystal On Silicon (LCOS) imagers are gaining popularity in projection system applications such as rear-projection televisions. LCOS projection systems require polarized light, which can be modulated by the LCOS imager. Typically, a polarizing means, such as a polarizing beam splitter (PBS) is used to separate light by polarization, allowing light of the desired polarization to pass to the LCOS imager, and deflecting light of the undesired polarization away from the projection path. One of the problems with systems using polarized light in a projection system is the inherent waste in such systems by “throwing away” half (or more) of the light being produced by the lamp (i.e., the undesired polarization light) in the process of producing light of the desired polarization.

One approach to provide polarized light and recapture a portion of the alternately polarized light uses an integrator having small input and output apertures surrounded by reflective surfaces. A polarization means is disposed within the integrator to pass only light of a desired polarization. A quarter-wave plate (QWP) surrounds the output aperture, such that polarization of the light continues to be rotated and the light is reflected back into the integrator until it is both incident on the output aperture and has the desired polarization. This approach, however, is complicated and expensive to produce and maintain. Also, heat generated by the QWP and polarization means is difficult to dissipate, due to their location within the integrator. Additionally, placement of the QWP and polarization means within the integrator requires significant redesign of the entire illumination system.

### SUMMARY OF THE INVENTION

A polarized light source, is provided, comprising a lamp providing randomly polarized light, an integrator for directing light from the lamp generally along an axis of the integrator, and a wire-grid polarizer disposed at one end of the integrator. This polarized light source recovers a portion of the light produced by the lamp having an undesired polarization. A Liquid Crystal on Silicon (LCOS) light engine including a polarized light source with polarization recovery is also provided.

### BRIEF DESCRIPTION OF THE DRAWINGS

An exemplary embodiment of the present invention is described below with reference to the drawings in which:

FIG. 1 shows a polarized light source according to an exemplary embodiment of the invention; and

FIG. 2 shows a Liquid Crystal on Silicon (LCOS) light engine according to an exemplary embodiment of the invention.

### DETAILED DESCRIPTION OF THE INVENTION

In an exemplary embodiment of the present invention, an apparatus provides polarized light and recovers a portion of such light having an alternate polarization. A lamp 10 produces light 2 with random polarization. The lamp 10 may be, for example, a mercury arc lamp having an elliptical or a parabolic reflector (not shown) for directing light in a desired direction, such as a UHP™ lamp from Philips Lighting of Eindhoven, The Netherlands, or another UHP-type lamp.

The random polarization light 2 enters an integrator 20, which directs the random polarization light along an axis of the integrator 20. As is known in the art, the integrator 20 may comprise an elongate hollow structure having reflective inside surfaces that reflect the randomly polarized light 2 to channel it through the integrator 20 from an input aperture 21 disposed at an input end 22 of the integrator 20 to an output aperture 23 disposed at an output end 24 of the integrator 20. Alternatively, the integrator 20 may comprise a solid transparent elongate structure with a reflective coating, such as silver plating applied to its surfaces to reflect the randomly polarized light 2 to channel it through the integrator 20 from the input aperture 21 disposed at the input end 22 to the output aperture 23 disposed at the output end 24. For use in a projection system, the integrator 20 preferably has a rectangular output aperture 23 having the same aspect ratio as the desired image to be projected (e.g., 9×16).

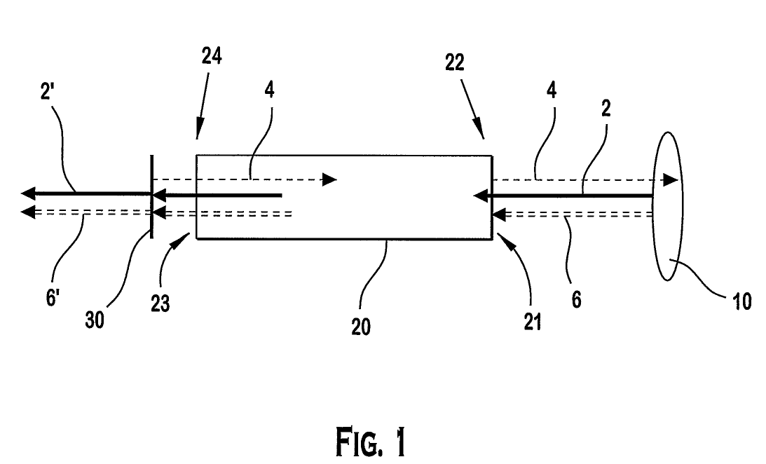

A primary polarizer 30 is disposed at an end 22, 24 of the integrator 20. In the embodiment shown in FIG. 1, the polarizer 30 is a reflective wire-grid polarizer operating in the visible light spectrum and disposed at the output end 24 of the integrator 20, proximate to and aligned with the output aperture 23. Moreover, in the exemplary polarized light source illustrated in FIG. 1, only a clean-up polarization means is required in addition to the polarizer 30. This is an improvement over existing systems using multiple polarizers. As will be appreciated by those skilled in the art, light of a desired polarization 2′ passes through polarizer 30 while light of an alternate or undesired polarization is reflected.

The reflected light 4, having an undesired polarization, is channeled back through the integrator 20 to the lamp 10, where it is reflected back toward the integrator 20. The inventors have determined that the lamp rotates the polarization of a portion of the reflected light 4 from an undesired polarization to the desired polarization. Thus, recycled light 6, the portion of light reflected by the lamp 10 and having the desired polarization is channeled through the integrator 20 and passes through the polarizer 30.

A portion of the recycled light 6 is again rejected, and again recycled. The total recycled light 6′ is equal to the cumulative light of the desired polarization that passes through the polarizer 30 throughout this recycling process. The total polarized light output provided by the exemplary polarized light source is equal to the initial desired polarization light 2′ plus the total recycled light 6′.

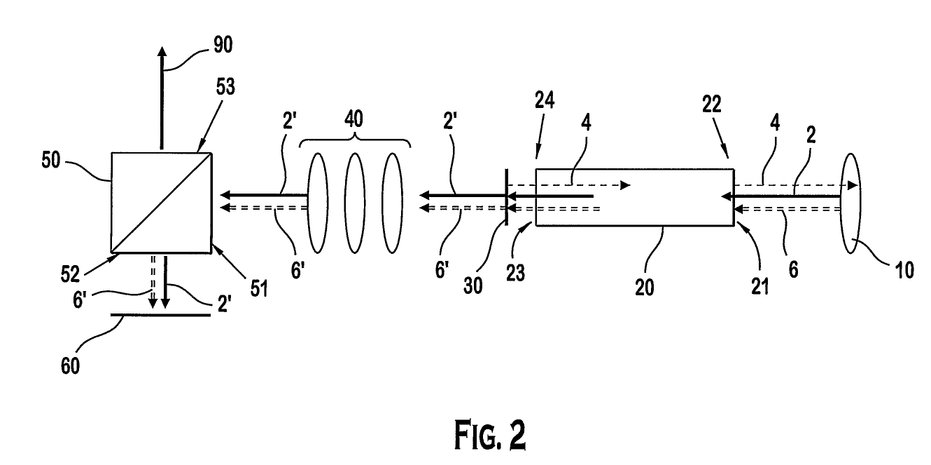

FIG. 2 shows an exemplary embodiment of the present invention, in which an LCOS light engine is provided using a polarized light source with polarization recovery. A lamp 10 produces random polarization light 2, which is directed toward the integrator 20 by a parabolic or elliptical reflector (not shown) in the lamp 10. The random polarization light 2 is channeled by the integrator 20 from an input aperture 21 at an input end 22 to an output aperture 23 at an output end 24. A polarizer 30 is disposed proximate the output end 24, aligned with the output aperture 23. The polarizer 30 is preferably a reflective wire grid polarizer operating in the visible light spectrum. As described above, light having a preferred polarization, as defined by the orientation of the wire-grid of the polarizer 30, passes through the polarizer 30, while light having undesired polarization is reflected by the polarizer 30. Recycled light 6′ having the desired polarization also passes through the polarizer. Also, because the wire-grid polarizer 30 is located proximate the end of the integrator 20, the light from the integrator 20 does not have an opportunity to diverge so that the wire-grid polarizer 30 used in the exemplary embodiment of the present only needs to be slightly larger than the output aperture 23 of the integrator 20.

After passing through the polarizer 30, the polarized light having the desired polarization 2′, 6′ is focused by a relay lens set 40 into an imaging assembly. The imaging assembly comprises a polarizing beam splitter (PBS) 50 and an LCOS imager 60. The PBS 50 passes light of one orientation through and deflects light of an opposite polarization. In the embodiment illustrated in FIG. 2, light having the desired polarization enters a first face 51 of the PBS 50 and is deflected through a second face 52 onto the LCOS imager 60. The LCOS imager modulates the light on a pixel-by-pixel basis to form a matrix of modulated pixels of light 90, rotates the polarization of the modulated light, and reflects the modulated light back through second face 52. Because the matrix of modulated pixels of light 90 has a polarization opposite to the polarization of the polarized light 2′, 6′, it passes through the PBS 50 and out of third face 53. A projection lens set (not shown) then projects the matrix of modulated light 90 onto a screen (not shown) to form a viewable image.

In addition to directing the polarized light 2′, 6′ to the LCOS imager 60 and directing the matrix of modulated pixels of light 90 to the projection lens set, the PBS 50 also performs clean-up polarization (i.e., it prevents leakage of light having an undesired polarization from passing to the LCOS imager 60). Although the PBS 50 is used for clean-up polarization in the illustrated embodiment, because it is needed for creating the LCOS projection path, other polarization means may be used for clean-up polarization, such as a linear polarizer.

One advantage of the present invention is that no change is required to existing light engine (or imager) architecture. Thus, a significant cost reduction may be realized as compared to a system that requires a redesign of the light engine architecture. Also, since the wire-grid polarizer 30 used in the exemplary embodiment of the present invention only needs to be slightly larger than the output aperture of the integrator, the surface area of the wire-grid polarizer (and thus its cost) is reduced by at least a factor of four, as compared to a polarizer disposed proximate the imager assembly (i.e., after the relay lens set). Due to its proximity to an end 22, 24 of the integrator 20, the polarizer 30 need only be about the size of the aperture 21, 23 to which it is proximate, plus a guard band to prevent edge leakage. Thus, the polarizer 30 can be smaller, and therefore less expensive, than a polarization means disposed proximate an imaging assembly.

With an integrator having an oversize light pipe (16×9×80 mm), lumen throughput may be increased by about 19%. With a more typically sized light pipe (8×4.5×40 mm) lumen throughput may be increased by about 14%.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A light source, comprising:
a lamp providing randomly polarized light;
an integrator for directing light from the lamp along an axis of the integrator; and
a wire-grid polarizer disposed at a first end of the integrator.

2. The light source according to claim 1, wherein the wire-grid polarizer is disposed at a light input end of the integrator.

3. The light source according to claim 1, wherein the wire-grid polarizer is disposed at a light output end of the integrator.

4. The light source according to claim 1, wherein the lamp is a mercury arc lamp with an elliptical or a parabolic reflector.

5. The light source according to claim 1, wherein a second end of the integrator is free of any polarization means.

6. A Liquid Crystal on Silicon (LCOS) light engine, comprising:
a lamp providing randomly polarized light;
an integrator for directing light from the lamp along an axis of the integrator;
a wire-grid polarizer disposed at a first end of the integrator; and
a Liquid Crystal on Silicon (LCOS) imager for modulating the polarized light from the integrator on a pixel-by-pixel basis responsive to a video signal to form a video image.

7. The Liquid Crystal on Silicon (LCOS) light engine according to claim 6 further comprising a clean-up polarization means disposed between the wire-grid polarizer and the Liquid Crystal on Silicon (LCOS) imager.

8. The Liquid Crystal on Silicon (LCOS) light engine according to claim 7 wherein the clean-up polarization means is a polarizing beam splitter.

9. The Liquid Crystal on Silicon (LCOS) light engine according to claim 7 wherein the clean-up polarization means is a linear polarizer.

10. The Liquid Crystal on Silicon (LCOS) light engine according to claim 6, wherein the wire-grid polarizer is disposed at a light input end of the integrator.

11. The Liquid Crystal on Silicon (LCOS) light engine according to claim 6, wherein the wire-grid polarizer is disposed at a light output end of the integrator.

12. The Liquid Crystal on Silicon (LCOS) light engine according to claim 11, wherein the wire-grid polarizer is about the size of the output end of the integrator.

13. The Liquid Crystal on Silicon (LCOS) light engine according to claim 6, wherein the lamp is a mercury-arc lamp with an elliptical or a parabolic reflector.

14. The Liquid Crystal on Silicon (LCOS) light engine according to claim 6, wherein a second end of the integrator is free of any polarization means.
